(19) United States
(12) Patent Application Publication
(10) Pub. No.: US 2025/0240257 A1
(43) Pub. Date: Jul. 24, 2025

(54) SYSTEM AND METHOD FOR PROVIDING SEARCH SERVICE WITH CHATROOM

(71) Applicant: Kakao Corp., Jeju-si (KR)

(72) Inventors: Eun Ju OH, Seongnam-si (KR); Eun Jung LEE, Seongnam-si (KR); Soo Yeun JANG, Seongnam-si (KR); Su Min CHO, Seongnam-si (KR); Seung Hyung LEE, Seongnam-si (KR); Maria PARK, Seongnam-si (KR); Hye Jin KANG, Seongnam-si (KR)

(21) Appl. No.: 19/002,967

(22) Filed: Dec. 27, 2024

(30) Foreign Application Priority Data
Jan. 18, 2024 (KR) 10-2024-0008020

(51) Int. Cl. H04L 51/02

(52) U.S. Cl. CPC H04L 51/02

(57) ABSTRACT

Provided is a method for operating a user terminal, the method including: generating a specific space in connection with a chatroom; acquiring, from a server, an answer to a query input or selected in the chatroom or in the specific space; and displaying the query and the answer in the specific space. The specific space is configured to cumulatively display queries and answers input or selected in the chatroom or in the specific space.

### CROSS-REFERENCE TO RELATED APPLICATION

This application claims priority to and the benefit of Korean Patent Application No. 10-2024-0008020 filed in the Korean Intellectual Property Office on Jan. 18, 2024, the entire contents of which are incorporated herein by reference.

### BACKGROUND

### (a) Field

The present disclosure relates to a search service.

### (b) Description of the Related Art

Information search may require finding a specific target with relevant information, and a relationship may be required to be established, such as through conversational participation, before accessing the information. In addition, the information may be fragmented, making it challenging to comprehensively search for desired information using traditional search methods.

Recently, technologies enabling conversational interaction with large language models, such as generative pre-trained transformers (GPT), have been spotlighted. The GPT may serve as an effective information search tool as the GPT understands the user's context and intent through natural language processing, and provides the information by synthesizing and summarizing the same. A method is required to leverage this GPT capability in a search service.

### SUMMARY

The present disclosure attempts to provide a system and a method for providing a search service with a chatroom.

The present disclosure attempts to provide an interface screen that provides a search service in connection with a chatroom.

According to some embodiments, provided is a method for operating a user terminal, the method including: acquiring, from a server, an answer to a query input or selected in a chatroom or in a specific space, the specific space being in connection with a chatroom; and displaying the query and the answer in the specific space. The specific space is configured to cumulatively display queries and answers input or selected in the chatroom or in the specific space.

A session of the specific space may be maintained dependent on a session of the chatroom.

The method may further include: transmitting a sharing request for the query and the answer to the server; and displaying a search result including the query and the answer in the chatroom.

The search result shared in the chatroom may further include a button configured to perform a follow-up query function in a context of the query and the answer.

The displaying the query and the answer in the specific space may include: transmitting the query input or selected in the chatroom switched to a search mode to the server; and displaying the answer to the query in the specific space.

The displaying the query and the answer in the specific space may include: in response to a request for a follow-up query related to a search result shared in the chatroom, switching the chatroom to a search mode; transmitting the query input or selected in the chatroom to the server; and displaying the answer to the query in the specific space.

The displaying the query and the answer in the specific space may include, response to a request for a full view of a search result shared in the chatroom, displaying the entire answer included in the shared search result in the specific space.

The method may further include: folding the specific space in response to a user action and displaying, in the chatroom, an entry point configured to enable entry into the specific space; and unfolding and displaying the specific space in response to a selection of the entry point.

The method may further include: displaying a previous query list in the specific space; and displaying an answer to a query selected from the previous query list in the specific space.

According to some embodiments, provided is a method for operating a server, the method including: receiving a query input or selected in a chatroom or in a specific space from a user terminal, the specific space being maintained dependent on a session of the chatroom; and generating an answer to the query and providing the answer to the specific space. The specific space is configured to cumulatively display queries and answers input or selected in the chatroom or in the specific space.

The method may further include: receiving a sharing request for the query and the answer from the user terminal; and providing a search result including the query and the answer to the chatroom.

The search result shared in the chatroom may further include a button configured to perform a follow-up query function in a context of the query and the answer.

The method may further include: receiving an additional query input from a terminal of a participant within the chatroom, the chatroom being switched to a search mode in response to a selection of the button; generating an answer to the additional query in the context of the query and the answer; and providing the answer to the additional query to a specific space for the participant that is maintained dependent on the session of the chatroom.

The method may further include: in response to a termination of the session of the chatroom, terminating a session of the specific space and storing, in a query list, at least one query recorded in the specific space while the session of the specific space is maintained.

The method may further include providing the query list to the specific space.

According to some embodiments, provided is an application stored on a computer- readable storage medium and executed by a processor, the application including instructions for executing: acquiring, from a server, an answer to a query input or selected in a chatroom or in a specific space, the specific space being in connection with a chatroom; and displaying the query and the answer in the specific space. The specific space is configured to cumulatively display queries and answers input or selected in the chatroom or in the specific space.

The application may include instructions for further executing: transmitting a sharing request for the query and the answer to the server; and displaying a search result including the query and the answer in the chatroom. The search result shared in the chatroom may further includes a configured to performbutton configured to perform a follow-up query function in a context of the query and the answer.

The displaying the query and the answer in the specific space may include: transmitting the query input or selected in the chatroom switched to a search mode to the server, and displaying the answer to the query in the specific space; in response to a request for a follow-up query related to a search result shared in the chatroom, switching the chatroom to the search mode, transmitting the query input or selected in the chatroom to the server, and displaying the answer to the query in the specific space; or in response to a request for a full view of the search result shared in the chatroom, displaying the entire answer included in the shared search result in the specific space.

The application may include instructions for further executing: folding the specific space in response to a user action and displaying, in the chatroom, an entry point configured to enable entry into the specific space; and unfolding and displaying the specific space in response to a selection of the entry point.

The application may include instructions for further executing: displaying a previous query list in the specific space, and displaying an answer to a query selected from the previous query list in the specific space.

According to the embodiment, the chatroom may be switched to the search mode to provide the search service, enabling the information search and the information sharing during conversations. The queries and answers may be recorded in a separate space in connection with the chatroom.

According to the embodiment, it is possible to recognize the search context for existing queries and answers, generate the answer through the continuous exploration that preserves the context, and generate the answer by summarizing the integrated information obtained from the various sources, thereby providing the optimal search result.

According to the embodiment, it is possible to recommend the various types of queries, thereby enhancing the convenience of query input and the accessibility to the search service, thereby prompting the search service.

According to the embodiment, the user may query in the chatroom while maintaining the context until reaching the desired information, review the queries and answers in the separate space in connection with the chatroom, and enter the additional query while preserving the context of the search result shared in the chatroom.

### BRIEF DESCRIPTION OF THE DRAWINGS

FIG. 1 is a schematic configuration diagram of a service system according to an embodiment.

FIGS. 2 to 8 are examples of an interface screen on a terminal according to an embodiment.

FIG. 9 is an example of a server structure for providing a search service according to an embodiment.

FIG. 10 is a flow chart of a method for providing a search service by a server according to an embodiment.

FIGS. 11 and 12 are flow charts of a method for providing a search service by a terminal according to an embodiment.

### DETAILED DESCRIPTION OF THE EMBODIMENTS

Hereinafter, embodiments of the present disclosure are described in detail with reference to the accompanying drawings so that those skilled in the art to which the present disclosure pertains may easily practice the present disclosure. However, the present disclosure may be implemented in various different forms and is not limited to the embodiments provided herein. In addition, in the drawings, portions unrelated to the description are omitted to clearly describe the present disclosure, and similar portions are denoted by similar reference numerals throughout the specification.

Throughout the specification, when any one part “includes” any one component, it may indicate the inclusion of other components rather than the exclusion of other components unless explicitly described to the contrary. In addition, the terms “part”, “module”, and the like, described in the specification indicate a unit of processing at least one function or operation and may be implemented by hardware or software or a combination of hardware and software.

A server may include one or more processors, a memory that loads a computer program executed by the processors, a storage device that stores the computer program in and various data, and a communication interface. In addition, the server may include various other components. The processor may be a device that controls an operation of the server, and may be any of a variety of processors that process instructions included in the computer program. For example, the processor may include at least one of a central processing unit (CPU), a micro processor unit (MPU), a micro controller unit (MCU), a graphics processing unit (GPU), or any other processor widely known in the art of the present disclosure. The memory may store the various data, instructions, and/or information. The memory may load the corresponding computer program from the storage device for the instructions described to operate the present disclosure to be processed by the processor. The memory may be, for example, a read only memory (ROM), a random access memory (RAM), or the like. The storage device may store the computer program and the various data non-temporarily. The storage device may include a non-volatile memory such as the read only memory (ROM), an erasable programmable ROM (EPROM), an electrically erasable programmable ROM (EEPROM), or a flash memory, a hard disk, a removable disk, or any form of computer readable recording medium widely known in the art to which the present disclosure pertains. The communication interface may be a wired/wireless communication module that supports wired/wireless communication. The computer program may include instructions that are executed by the processor and be stored in a non-transitory computer readable storage medium, the instructions causing the processor to perform operations in the present disclosure.

A terminal may include the computer program, which is software stored in the computer-readable storage medium, and hardware such as the processor, the memory, a display, or the communication module. The processor may collaborate with the hardware to execute the computer program. The display may display a user interface screen provided by the computer program and receive user input, for example, touch input. The communication module may communicate with the server through a communication network. The computer program may be software stored on the computer-readable storage medium, and include the instructions and data for executing the operation in the present disclosure. The computer program may include an application.

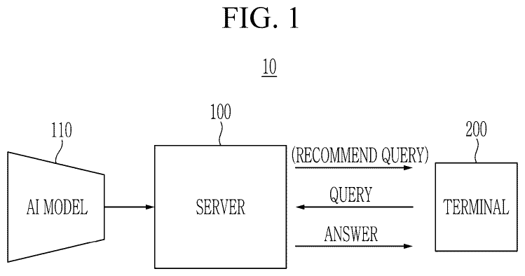

FIG. 1 is a schematic configuration diagram of a service system according to an embodiment.

Referring to FIG. 1, a service system 10 may include a server 100 and a terminal 200 that installs an application and communicates with the server 100. The server 100 may be implemented to provide the terminal 200 with a specified service in conjunction with at least one artificial intelligence (AI) model 110. The various AI models 110 may be provided. For example, the AI model 110 may include large language models (LLM) such as generative pre-trained transformers (GPT), generate-type AI models, or conversation-type AI models. The AI model 110 may include a commercially available model and a model specialized for the present disclosure.

The server 100 may provide a chat service for supporting message exchange in a chatroom. Here, the chat service is not limited to the chat service based on acquaintances (friends) but may also include the chat service based on non-acquaintances or anonymity. It may encompass various forms and names of chat services that provide chat rooms. The chat service based on a non-acquaintances or anonymity may include, for example, an open chat service provided by the KakaoTalk application.

The server 100 may provide a search service, and especially the search service in the chatroom. The server 100 may search for information relevant to a query intent through search database exploration or in conjunction with the AI model 110, and generate an answer by synthesizing the searched information. The server 100 may classify queries into a plurality of classes, such as precise search intent and generative search intent, using a query intent classification model and determine the query intent based on the probability of each class. Here, a method for analyzing the query intent may be implemented in various ways.

The server 100 may analyze the query intent regardless of a query format (e.g., keyword query or sentence query) and generate an answer in a form suitable for the identified query intent. If the server 100 analyzes the query intent as the precise search intent, the server 100 may search a search database for information corresponding to a precise answer and generate the answer using the retrieved information. The search database may include various types of collections (e.g., people collection and movie collection). If the query intent may not be the precise search intent, this query intent may be classified as the generative search intent. Generative search refers to the process of generating the answer in a new form by summarizing integrated information. Integrated information may be acquired through the large language model, such as the GPT, and various accessible sources, including social media platforms (e.g., news and blogs), and document databases. The server 100 may generate the answer by combining precise search and the generative search in a complementary manner. That is, the server 100 may ensures that the answer obtained by the precise search and the generative search do not overlap. For example, the server 100 may distinguish between sources explored for the precise search and the generative search. If the query matches a people dictionary in the search database, the precise search may focus on the people collection, while the generative search may gather articles related to the queried person from news sources. If the query matches a place dictionary in the search database, the precise search may be performed on a place collection, and the generative search may be performed to search for information (e.g., reviews or ratings) related to the queried place from social media sources.

There are no restrictions on the query format, and a query that is ambiguous, requires value determination, or involves emotional exchange may be entered. Since providing a precise answer to such a query may not be feasible, the server 100 may generate the answer by summarizing integrated information obtained through the AI model 110, which is trained using various data. The server 100 may additionally provide a user with related content (e.g., videos, music, reference documents, or websites) that is accessible to the user together with the answer. In this way, the server 100 may provide a search result optimized for the query intent.

A method for generating an answer to a query by the server 100 may be implemented in various ways. For example, the server 100 may segment the received query into semantic units, combine words corresponding to these semantics, query the search database (e.g., collections), and determine a reliable answer as the result of the precise search. For example, if the query is “Is GOTG3 fun?”, the server 100 may extract “GOTG3” and “fun” from the query, replace “GOTC3” with “Guardians of the Galaxy 3” or similar terms, expand “fun” with words such as “reaction”, “review”, “analysis”. The server 100 then query the search database (e.g., collections) using a combination of the replaced and expanded terms. Among these combinations, if an answer to “GOTG3 reaction” is deemed accurate, the server 100 may determine this answer to the query “Is GOTG3 fun?”. Alternatively, the server 100 may input the query “Is GOTG3 fun?” into at least one AI model 110 and generate the answer based on the model's output.

A method for determining the exposure order of answers by the server 100 may be implemented in various ways. For example, if a query closely matches information stored in the search database (e.g., the people collection), the query intent is more likely to correspond to the precise search intent. In such cases, the answer acquired through the precise search may be prioritized and exposed first. Conversely, if fewer answers are acquired from the search database for the query, it is more likely that the query intent corresponds to the generative search intent. In such cases, the answer generated through the generative search may be prioritized and exposed first, followed by the precise search or related content. Alternatively, the server 100 may determine the exposure order of the answers to be provided later based on responses information for similar queries with the answers. For example, the server 100 may provide various types of answers (e.g., precise answer and generative answer) to the users who entered queries similar to “Is GOTG3 fun?”, accumulate responses information (e.g., clicks), and prioritize displaying the answer type that receives a high response rate.

The server 100 may provide a query-related advertisement by incorporating it into the answer. The query-related advertisement may be provided in various forms. For example, an answer to the query “When is the cheapest time to fly from Gimpo to Jeju?” may include an advertisement for a flight ticket sales website together with the generative answer. An answer to the query “Recommend a nutritional supplement for women in their 20s” may include an advertisement for a nutritional supplement product together with the generative answer.

The server 100 may provide a recommended query within the answer. If the recommend query included in the answer is selected, the server 100 may provide an answer to the selected query.

The server 100 may recognize the search context for previous queries and answers, and generate an answer to the current query through continuous exploration that maintains the context. The server 100 may recognize the conversation context in the chatroom and generate an answer to a query accordingly. If the server 100 explores the answer to the current query, the server 100 may acquire a context-aware answer by connecting the previous query and answer, or at least a portion of conversation content, to the current query and inputting this information into the AI model 110. However, a method for acquiring the context-aware answer may be implemented in various ways.

The server 100 may recommend an input query to the user. For example, the server 100 may recommend a popular query determined based on query statistics from users to the terminal 200. An answer to a popular query may be either pre-stored or newly generated. The server 100 may recommend the newly trending query generated based on the latest news to the terminal 200. The server 100 may recommend a query related to an input text to the terminal 200. The server 100 may recommend a random query that may be randomly selected to the terminal 200. The server 100 may recommend a chatroom-specific query considering the conversation context in the chatroom, or a user-specific query considering the user information such as the user's interests. In this way, the server 100 may reduce the inconvenience of users inputting queries and support the user in using the search service conveniently and enjoyably.

The terminal 200 may execute the application and access the server 100 to use the chat service and the search service, implemented in the application. In the present disclosure, the search service may be provided by being integrated with the chat service. The terminal 200 may be any type of computing device capable of displaying the interface screen provided by the application and receiving the user input. The description describes a mobile terminal as an example, and the terminal 200 is not limited thereto. The terminal 200 may include at least one processor for executing instructions included in the application, and the processor may execute the instructions to perform an operation described in the present disclosure. The application including the instructions may be stored on a computer-readable storage medium.

The terminal 200 may provide various entry points in the chatroom to enter the search mode. For example, the chatroom may switch from chat mode to search mode, when a message input window in the chatroom is converted into a query input window through a specified user action in the chatroom (e.g., selecting a search button). The message input window may serve as a prompt input window for the user to input a query. Alternatively, through the selection of a message region displayed in chatroom, the search for a text or an image included in the message is requested. For example, a menu displayed if the user long-taps on the message region includes an option like “Ask a question”, and if the user selects the option “Ask a question”, a search request for the selected message is transmitted to the server 100.

The terminal 200 may receive the answer to the query from the server 100 and display the answer. The answer may be provided as the precise answer, the generative answer, or an answer including both the precise answer and the generative answer, based on the query intent analyzed by the server 100, and the type of answer and the order of the answers may be determined based on the query intent.

The query and the answer may be displayed in various ways in connection with the chatroom. For example, the terminal 200 may provide a separate space where the query and the answer are displayed in a conversation format. In the present disclosure, the separate space in connection with the chatroom and providing the search service is referred to as a “search room”, and its name may be determined in various ways, such as “Chunsik's room”. The search room may be generated in connection with the chatroom, with a search room session initiated through the entry point implemented in the chatroom. A folded search room may appear as a floating button in the chatroom. The search room may be implemented for the user to conveniently enter the search room from the chat room by selecting the floating button. The search result (or the query and the answer) displayed in the search room may be shared to and displayed in the chatroom. The search room may also provide the query input window, and display the answer to the query input into the query input window. The answer displayed in the search room may be generated through the continuous exploration that follows the search context of the previous queries and answers. The search room session may be maintained while the chatroom session is active. That is, while the chatroom session is maintained (for example, while the chatroom is open), the queries and the answers may be accumulated in the search room where the search room session is maintained. The server 100 may generate answers fitting the context based on the accumulated data. If the chatroom session is terminated (for example, if the chatroom is closed), the search room session may also be terminated. At least one query requested in this session may be stored in a query list. The user may review previous queries in a newly connected search room session through the stored query list.

The terminal 200 may display the recommended query for user selection in a specific region. The specific region may be, for example, a region around the message input window (e.g., suggestion region). The recommended query may include, for example, the popular query, the newly trending query, an input text related query, or the random query. By selecting a recommended query, the user may acquire the search result related to the query without manually entering a query, enabling access to desired information during the conversation without needing to visit a separate search platform.

Additionally, the terminal 200 may recognize text being entered into the query input window and display an answer related to the input text in advance in the designated region (e.g., the suggestion region).

Through this service system 10, users may conveniently conduct searches during the conversation in the chatroom without needing to visit external Internet search platforms such as Daum, Naver, or Google. Traditional keyword searches, such as “#search”, may be limited to the precise search, and may thus be used only for simple one-time search. In contrast, the present disclosure allows users to conduct continuous searches in chatroom, while maintaining the context until they reach the desired information. In particular, users may review queries and answers in a dedicated space (referred to as the search room) in connection with the chatroom, and may also continue exploring information shared in the chatroom while preserving the context, enhancing the efficiency and depth of the search experience.

The following description describes in detail the interface screen displayed on the terminal 200.

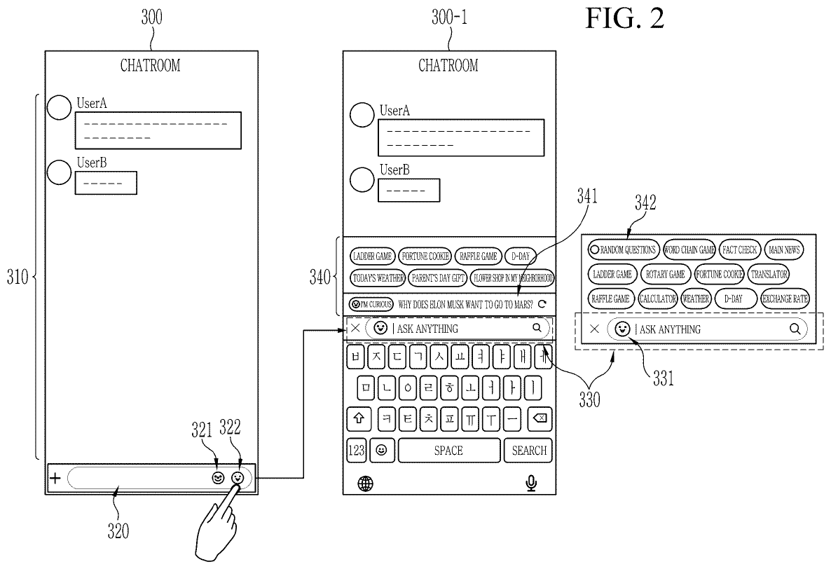

FIGS. 2 to 8 are examples of the interface screen on a terminal according to an embodiment.

Referring to FIG. 2, the terminal 200 may display a chatroom 300 provided by the application. The chatroom 300 may include a message display window 310 for displaying messages exchanged by participants, and a message input window 320 for receiving the user input such as text, photos, videos, or emoticons. If an emoticon button 321 is selected, an emoticon display window for showing the plurality of selectable emoticons may be displayed.

The chatroom 300 may provide the entry point that enables the switch from the chat mode to the search mode. For example, the chatroom 300 may display a search button 322 that enables entry into the search mode, and if the search button 322 is selected, the chatroom may transition to the search mode that enables the use of the search service in the present disclosure. For example, the search button 322 may be positioned near the message input window 320, and its position may be adjustable. Upon the selection of the search button 322, the message input window 320 may transform to a query input window 330, allowing users to enter queries.

In addition to the search button 322, the entry point that enables the entry into the search mode may be implemented in various ways. The chatroom may be switched to the search mode when a follow-up query for the search result shared in the chatroom is requested. In addition, selecting “Ask a question” from the menu that is displayed upon selecting the chatroom speech bubble (e.g., via a long-tap) may initiate a search for the text or the image included in the speech bubble.

A chatroom 300-1 switched to the search mode may display the query input window 330. The query input window 330 may serve as the prompt input window. The query input window 330 may further include an indicator 331 showing that the chatroom is in the search mode, along with a text guide encouraging query input (e.g., “Ask me anything”). The terminal 200 may transmit the query input into the query input window 330 to the server 100 and receive the answer to the query.

The chatroom 300-1 switched to the search mode may display at least one recommended query in a specific region 340. The specific region 340 may be referred to as the suggestion region. For example, the specific region 340 may be disposed around the message input window, displayed on an upper layer of the message display window 310, or displayed on the same layer as the message display window 310 in a region that pushed the message display window 310 upward.

The recommended query may include, for example, the popular query, the newly trending query, the input text related query, or the random query. The recommended query may be provided in a keyword form or a sentence form. For example, a keyword (e.g., “today weather”, “Parents' Day gift”, or “flower shop in my neighborhood”) may be displayed in bubble format within a designated region 340, while a sentence-form query 341 may be displayed in a separate, distinct area. The popular query, the newly trending query, the chatroom-specific query based on the ongoing conversation context in the chatroom, the user-specific query tailored to the user information such as the user's preferences and interests may be recommended as the sentence-form query 341. If the recommended sentence-form query 341 or keyword (e.g., “today weather”) is selected, the selected query may be transmitted to the server 100. The recommended keyword or sentence-form query 341 may be updated manually or automatically. Additionally, a random question bubble 342 having a randomly implemented query function may be displayed in the specific region 340. If the random question bubble 342 is selected, the terminal 200 may receive a randomly selected query from the query list and its answer to the query.

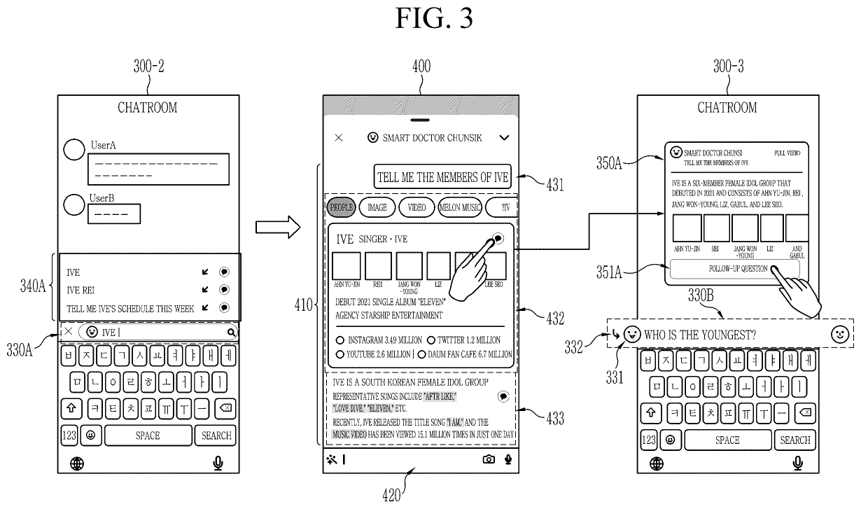

Referring to FIG. 3, if the text is entered into a query input window 330A of a chatroom 300-2 that is switched to the search mode, the chatroom 300-2 may display at least one recommended query related to the input text in a designated region 340A. While the text is being entered, the recommended query may be dynamically updated to match the input text. The recommended query may be provided in the keyword form or the sentence form. For example, if the input text is “IVE”, Korean artist group, the recommended query may be “IVE”, “IVE REI”, “Tell me IVE's schedule this week”, or the like.

The terminal 200 may transmit the query input into the query input window 330A to the server 100 and display the received answer in a designated space, i.e., search room 400. The search room 400 in connection with the chatroom may be generated for each user who enters the query, and the search results with queries and answers for searches performed in the chatroom may be sequentially accumulated and displayed. The search room 400 may include a search display window 410 for displaying the queries and the answers and a query input window 420 for receiving the input query. If the query is entered into the query input window 420 in the search room 400, the query in a speech bubble form may be displayed in the search display window 410, and the answer received from the server 100 may be displayed. That is, the query displayed in the search room 400 may be a query input by the user in the search mode of the chatroom or a query input in the search room, and the queries and the answers may be accumulated and displayed in a form of the message. Therefore, when generating the answer to the input query, the server 100 may recognize the search context for existing queries and answers, and generate the answer to the current query through the continuous exploration that follows the context.

The search display window 410 may display the queries and their corresponding answers in the conversational format. For example, the search display window 410 may display a query “Tell me the members of IVE” 431 and its answers 432 and 433. Depending on the query intent analyzed by the server 100, the answer may be the precise answer, the generative answer, or a combination of both the precise answer and the generative answer. The type and the order of the answers may be determined based on the query intent. For example, for the query “Tell me the members of IVE” 431, the server 100 may determine that the precise search intent has a higher probability than the generative search intent through the query intent analysis, and may provide the terminal 200 with the search result including the answers generated based on the query intent. The search room 400 upon receiving the search result, may prioritize displaying the precise answer 432 derived from the people collection for “IVE”, and additionally display the generative answer 433, synthesized from the integrated information about “IVE”. The search result derived from the people collection may be provided in a card format, such as swiping through cards, though other presentation styles are also possible.

The search result may be shared in the chatroom. For example, if the terminal 200 transmits a sharing request for the precise answer 432 to the server 100, a shared search result 350A may be displayed in a chatroom 300-3. The shared search result 350A may inform chatroom participants the query by further including the query “Tell me the members of IVE” together with the shared answer. In addition, the shared search result 350A may further include a button (e.g., “follow-up question” button) 351A to facilitate follow-up queries in the context of the shared query and answer.

If the user selects the follow-up question button 351A, the message input window in the chatroom 300-3 may switch to a query input window 330B, allowing the user to input a follow-up query, such as “Who is the youngest?”. Here, the query input window 330B may further display an indicator 332 showing that the follow-up query is made in the context of the previous search, along with an indicator 331 showing that the chatroom is in the search mode. The server 100 may generate an answer to the follow-up query “Who is the youngest?” in the context of the previous query “Tell me the members of IVE” and its corresponding answer, and provide the same to the terminal 200.

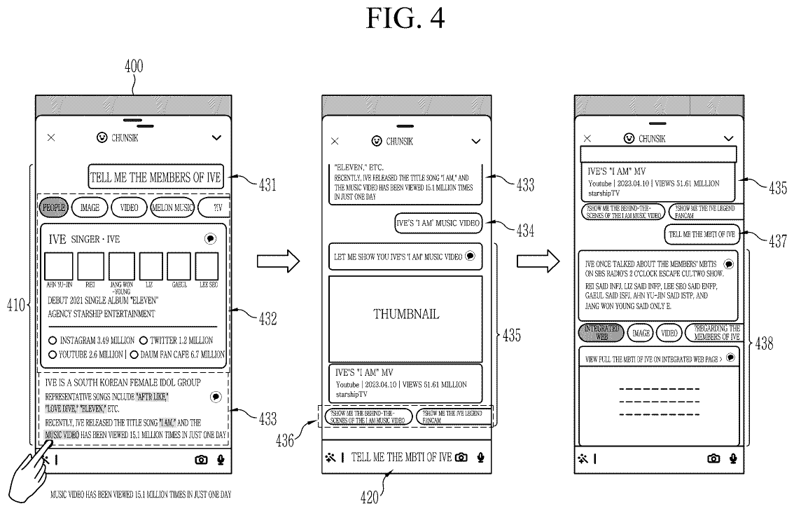

Referring to FIG. 4, the user may perform an additional search in the search room 400 in connection with the chatroom. For example, if a specific keyword, e.g., “music video”, is selected in the answer 433 that includes selectable keywords, the search room 400 may display a new follow-up query “IVE's ‘I AM’ music video” 434 and its answer 435, following the previous query and its answer 433. The selectable keyword may be configured to include a link for re-search.

The answer 435 may include at least one content that provides “IVE's ‘I AM’ music video”, and further include a recommended query 436, for example, “Show me the behind-the-scenes of the I AM music video”, “Show me the IVE legend fancam”, or the like. If the recommended query 436 is selected, the selected answer to the query may be displayed in the search room 400.

Meanwhile, if the query “Tell me the MBTI of IVE” is entered into the query input window 420, a new follow-up query 437 for the previous query and its answer 435 may be displayed in the search display window 410, and an answer 438 to the query may be displayed sequentially. The answer 438 may be provided as the generative answer, and implemented to provide information related to the query searched for from various platforms for a web, the image, the video, or the like.

In this way, the search room 400 may provide the answer to the query input in the chatroom, also provide an answer to the re-search or the input query through keyword selection in the answer, and support a continuous search operation without leaving to another page. In particular, the queries and the answers may be accumulated in the search room 400, and the server 100 may thus generate the answer by following the context in the search room 400, thus allowing the user to quickly and accurately acquire a desired answer without having to repeat the previous query.

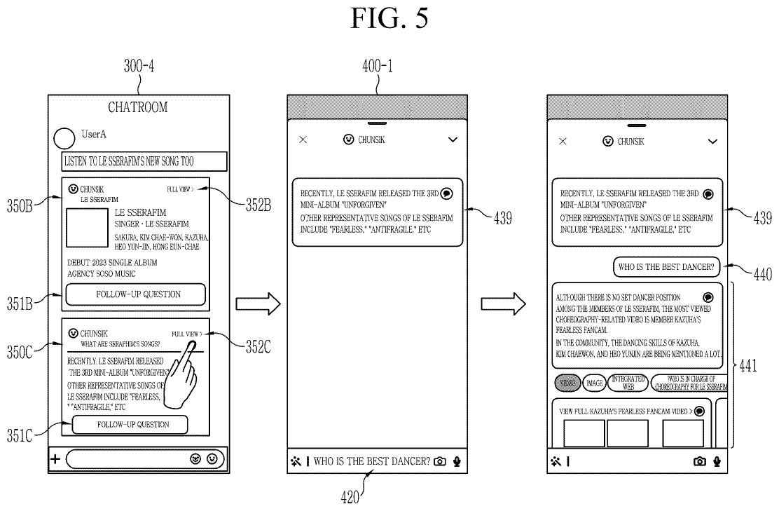

Referring to FIG. 5, a chatroom 300-4 may display the shared search results 350B and 350C. The shared search result 350B or 350C may further include a query “Le Sserafim” or “What are Le Sserafim's songs?” together with the shared answer, and further include a button (e.g., “follow-up question” button) 351B or 351C for the follow-up query in the context of the query and the answer. If the user selects the follow-up question button 351B or 351C, the message input window in the chatroom 300-4 may be switched to the query input window and receive the input query. The server 100 may generate an answer to an additional query in the context of the query “Le Sserafim” and “What is Le Sserafim's song?” and its answer, and provide the same to the terminal 200.

The shared search result 350B or 350C may further include a full view button 352B or 352C configured to perform a function to provide a full view of the shared result. If the user selects the full view button 352C, an entire answer 439 included in the shared search result 350C may be displayed in a search room 400-1. If the certain selectable keyword is selected from the answer 439, the search room 400-1 may display an answer to the selected keyword.

Meanwhile, if a query “Who is the best dancer” is entered into the query input window 420, a new follow-up query 440 and its answer 441 may be displayed after the previous answer 439. The answer 441 may be provided as the generative answer, and implemented to provide the information related to the query searched for from various platforms for the video, the image, or the like. The server 100 may generate the answer 441 to the query “Who is the best dancer” by following the context of “Le Sserafim song” in the search room 400-1, and the user may thus acquire the desired answer even if the user does not input “Who is the best dancer in Le Sserafim”. In this way, the user may review the search result shared by the chatroom participant, and enter the additional follow-up query in the context of the search result shared by the participant.

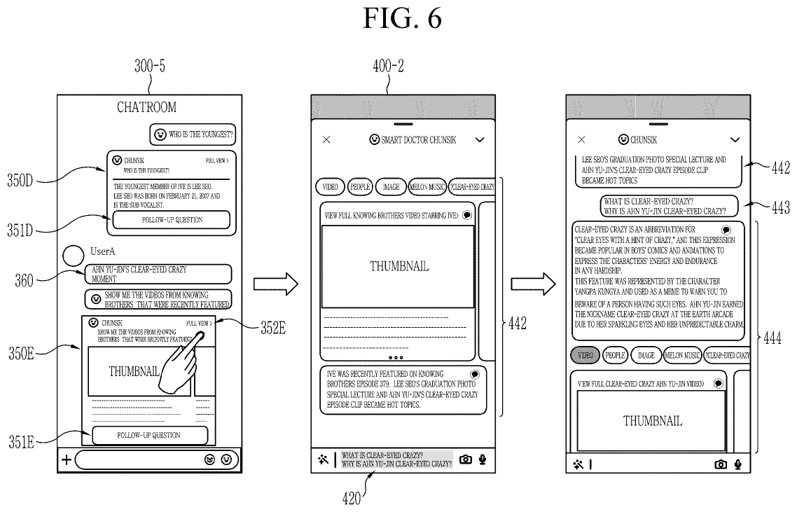

Referring to FIG. 6, the user may ask a question following the shared search result 350A in the chatroom 300-3 in FIG. 3, and share a search result 350D including this query and its answer in the chatroom. A chatroom 300-5 may display the search result 350D shared by the user.

The chatroom 300-5 may display a message 360 entered by a chatroom participant UserA and a search result 350E shared by UserA. Before sharing the search result, UserA may acquire the answer by asking a question following the search result shared by the user himself/herself or another participant, and share the search result 350E including the same. For example, UserA may select a follow-up question button 351D from the search result 350D shared by another participant in FIG. 3 to thus input a query “Show me the videos from Knowing Brothers that were recently featured”, and receive its answer. The server 100 may generate an answer to UserA's query “Show me the videos from Knowing Brothers that were recently featured” from the search context of the shared search result 350D and the conversation context inferred from the message 360 in the chatroom.

The shared search result 350E may further include the query “Show me the videos from Knowing Brothers that were recently featured” together with the shared answer, and include a button 351E for entering the follow-up query in the context of the corresponding query and answer, and a full view button 352E configured to perform the function to provide the full view of the shared result. The shared search result 350E may include the previously shared search result 350D and the answer generated in the context of the message 360.

If the user selects the follow-up question button 351E from the search result 350E shared by UserA, the message input window in the chatroom 300-5 may be switched to the query input window and receive the input query.

If the user selects the full view button 352E, an entire answer 442 included in the shared search result 350E may be displayed in a search room 400-2. If the certain selectable keyword is selected from the answer 442, the search room 400-2 may display the answer to the selected keyword.

Meanwhile, if a query “What is “clear-eyed crazy”? Why is Ahn Yu-jin clear-eyed crazy?” is entered into the query input window 420, a new follow-up query 443 and its answer 444 may be displayed after the answer 442. The answer 444 may be provided as the generative answer, and implemented to provide the information related to the query searched for from various platforms for the video, the people, the image, or the like.

As described above, according to the present disclosure, the server 100 may generate the answer to the query by considering the context. Accordingly, the chatroom participant may enter the follow-up query for the search result shared in the chatroom, review the search result shared in the chatroom in the search room of the participant, and enter the follow-up query for the previous query and answer in the search room of the participant.

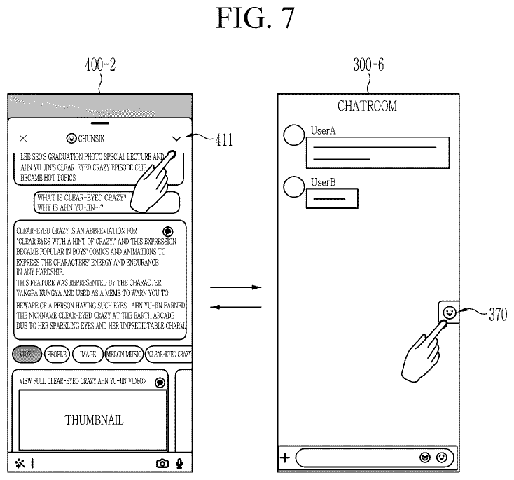

Referring to FIG. 7, the search room 400-2 may include a fold button 411 configured to perform a fold function. If the fold button 411 is selected, the search room 400-2 may be folded, and the entry point for enabling entry into the folded search room may be displayed in a chatroom 300-6. The entry point to the folded search room may be implemented as a floating button 370.

If the search room 400-2 where the previous query and answer are preserved is unfolded and the fold button 411 is selected in response to a selection of the floating button 370, the search room 400-2 may return to the chatroom 300-6 again.

The terminal 200 may fold the search room 400-2 by the user action, and display, in the chatroom 300-6, the entry point that enables the entry into the search room 400-2. The terminal 200 may unfold and display the search room 400-2 in response to selecting the entry point.

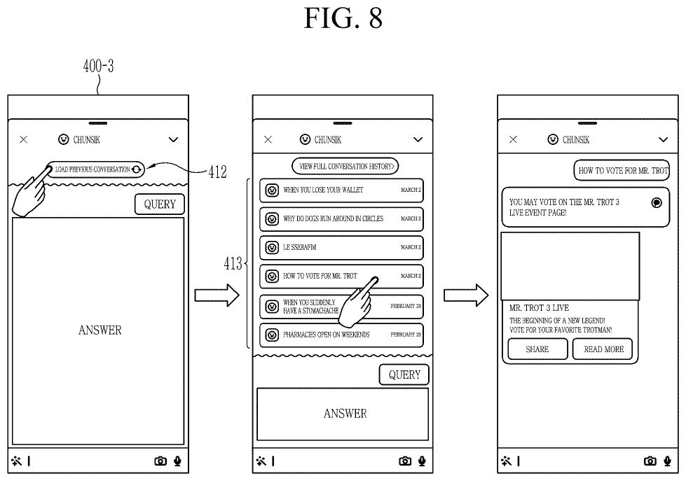

Referring to FIG. 8, a search room 400-3 may display a button (e.g., “load previous conversation” button) 412 configured to perform a function of loading the previous query. The load previous conversation button 412 may be displayed in the search room 400-3 through the designated user action such as a scrolling action.

If the user selects the load previous conversation button 412, the search room 400- 3 may display at least a portion of a previous query list 413. The search room 400-3 may display, for example, the most recent N query lists. The previous query list 413 may be generated for each chatroom session. The previous query list 413 may be generated in groups of similar contexts. For example, the user may query the group “Le Sserafim” in the chatroom, and then query another context. In this case, the server 100 may group queries having the similar contexts and display a representative query or a representative keyword (e.g., “Le Sserafim”) in the previous query list 413.

If a specific query is selected from the previous query list 413, the search room 400-3 may display an answer to the selected query. The previous query list 413 may only store the queries, and the search room 400-3 may acquire the latest answer from the server 100 and display the same when selecting the previous query.

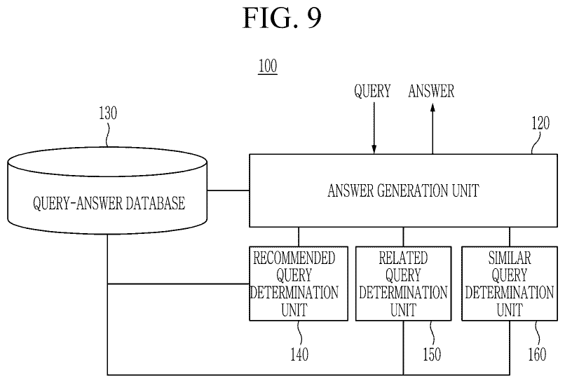

FIG. 9 is an example of a server structure for providing the search service according to an embodiment.

Referring to FIG. 9, the server 100 may generate the answers to the queries input from the terminal 200 and provide the same to the terminal 200. For this purpose, the server 100 may include an answer generation unit 120, a query-answer database 130, a recommended query determination unit 140, a related query determination unit 150, and a similar query determination unit 160. The answer generation unit 120, the query- answer database 130, the recommended query determination unit 140, the related query determination unit 150, and the similar query determination unit 160 may be some components of the server 100 and may be distinguished to each other to describe functions of the server 100, and the server structure for operating the present disclosure may be designed in various ways.

The answer generation unit 120 may search for the information suitable for the query intent through the search database exploration or in conjunction with the AI model, and generate the answer by synthesizing the searched information. The generated answer to the query may be stored in the query-answer database 130. The query and the answer may be stored in connection with the previous queries and answers, and information on the session where the query and the answer are generated (e.g., information on the user who enters the query and the chatroom where the query is entered) may be mapped. The query-answer database 130 may manage the queries separately, manage the answers separately, and manage the grouped queries or answers.

The answer generation unit 120 may generate the answer with the query-related advertisement. The answer generation unit 120 may provide the recommended query to the terminal 200 that is inputting the query, or generate the answer including the recommended query. For this purpose, the answer generation unit 120 may be in conjunction with the recommended query determination unit 140, the related query determination unit 150, and the similar query determination unit 160.

The recommended query determination unit 140 may determine the query to recommend to the user. The recommended query determination unit 140 may determine the popular query based on the query statistics of the users. The recommended query determination unit 140 may generate the newly trending query based on the latest news. The recommended query determination unit 140 may determine a random query list. The recommended query determination unit 140 may determine the chatroom-specific query considering the conversation context in the chatroom, or the user-specific query considering the user information such as the user's interests.

The related query determination unit 150 may generate a query group by grouping the queries stored in the query-answer database 130 based on relevance such as a subject or a field. If there is a query group that is highly related to a new query, the query or the answer included in the query group may be used to generate an answer to the new query.

The similar query determination unit 160 may generate the query group by grouping the queries stored in the query-answer database 130 based on similarity. If there is a query group that is highly similar to the new query, the query or the answer included in the query group may be used to generate the answer to the new query. For the sentence-form query, the sentences may often not be identical to each other even if the queries have similar meanings. Therefore, the similar query determination unit 160 may group the similar queries based on their meanings for query statistics processing, query recommendation, and answer generation.

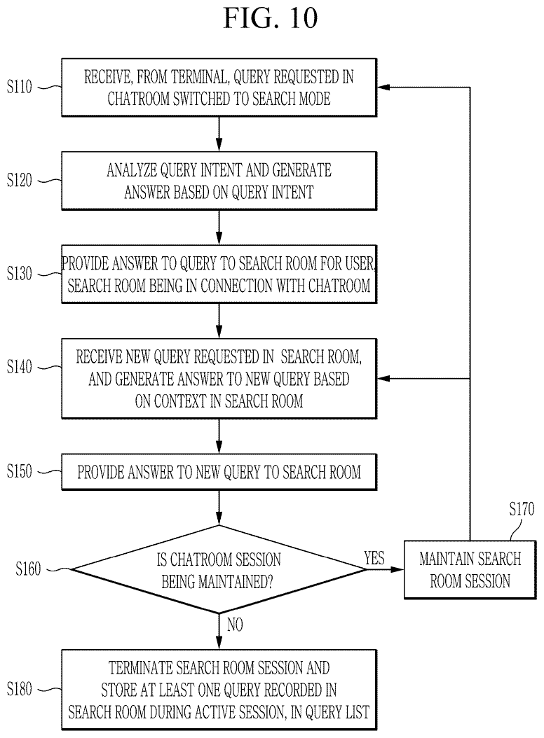

FIG. 10 is a flow chart of a method for providing a search service by a server according to an embodiment.

Referring to FIG. 10, the server 100 may receive, from the terminal 200, a query requested in the chatroom switched to the search mode (S110). The query may be the sentence-form query or the keyword query. The server 100 may provide the recommended query to the chatroom that is switched to the search mode. The recommended query may include, for example, the popular query, the newly trending query, the input text related query, or the random query. The query may be input into the query input window or selected from the recommended queries.

The server 100 may analyze the query intent and generate an answer based on the query intent (S120). The server 100 may generate the answer to the current query by considering the previous search context. The server 100 may generate the answer to the query in conjunction with the AI model 110. The server 100 may search the search database for the information corresponding to the precise answer and generate the answer by using the searched information. The server 100 may generate the answer by summarizing the integrated information acquired from the various sources. The server 100 may generate the answer by using the different search methods (e.g., precise search and generative search) in the complementary manner. The server 100 may determine the exposure order of the answers acquired through the precise search and the generative search based on the query intent. The server 100 may generate the answer that includes the query-related advertisement.

The server 100 may provide the answer to the query to the search room for the user, the search room being in connection with the chatroom (S130).

The server 100 may receive a new query requested in the search room, and generate an answer to the new query based on the context in the search room (S140).

The server 100 may provide the answer to the new query to the search room (S150).

The server 100 may determine whether the chatroom session is being maintained (S160).

If the chatroom session is being maintained, the server 100 may maintain the search room session in connection with the chatroom (S170). In this case, the server 100 may continuously provide the search room with answers to queries requested in the chatroom that is switched to the search mode, or the search room with answers to queries requested in the search room, while maintaining the search context.

If the chatroom session is terminated, the server 100 may terminate the search room session and store at least one query recorded in the search room during the active session, in a query list (S180). If the search room session is re-established, the server 100 may provide the query list to the search room.

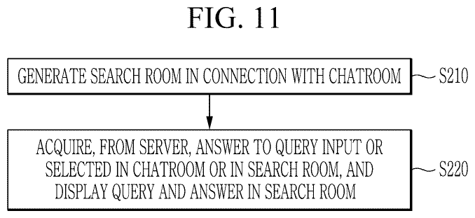

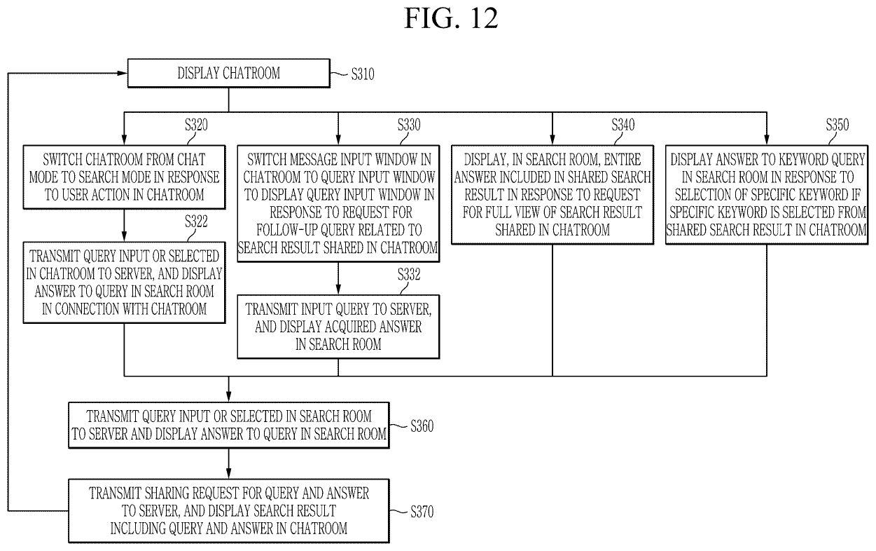

FIGS. 11 and 12 are flow charts of a method for providing a search service by a terminal according to an embodiment.

Referring to FIG. 11, the terminal 200 may generate the search room in connection with the chatroom (S210). The search room session may be maintained dependent on the chatroom session. That is, the search room session may also be maintained while the chatroom session is maintained.

The terminal 200 may acquire, from the server 100, an answer to a query input or selected in the chatroom or in the search room, and display the query and the answer in the search room (S220). The search room may cumulatively display the queries and the answers that are input or selected in the chat room or the search room. The terminal 200 may fold the search room in response to the user action, and display, in the chatroom, the entry point (e.g., floating button) that enables the entry into the search room. The terminal 200 may unfold and display the search room in response to a selection of the entry point.

Referring to FIG. 12, the terminal 200 may display the chatroom (S310).

The terminal 200 may switch the chatroom from the chat mode to the search mode in response to a user action in the chatroom (S320). The chatroom switched to the search mode may display the message input window by switching the same to the query input window. The user action may include selecting a button configured to perform the switch function to the search mode, or selecting a button configured to perform a follow- up query function (a continuous query function) related to the shared search result. The query input window may include the indicator showing the search mode. The terminal 200 may display the recommended query or a preview search result that the user may select in the specific region of the chatroom. The recommended query may include, for example, the popular query, the newly trending query, the input text related query, or the random query. The recommended query may include the keyword query or the sentence-form query. The terminal 200 may display the preview search result for the query being input into the query input window.

The terminal 200 may transmit the query input or selected in the chatroom to the server 100, and display the answer to the query in the search room in connection with the chatroom (S322). The search room in connection with the chatroom may be generated for each user who enters the query. The search room may sequentially accumulate and display the search results including queries and answers, searched in the chatroom or the search room. The search room may include the search display window for displaying the query and the answer and the query input window for receiving the input query. If the query is entered into the query input window in the search room, the query may be displayed in the search room, and then the answer to the query may be displayed.

The terminal 200 may switch the message input window in the chatroom to the query input window to display the query input window in response to a request for follow- up query (a request for continuous query) related to the search result shared in the chatroom (S330). The query input window may include the indicator representing the search mode, and the indicator representing that the follow-up query is being made. The shared search result may be the search result shared by the user, or may be the search result shared by another participant in the chatroom.

The terminal 200 may transmit the input query to the server 100, and display the acquired answer in the search room (S332). The answer may be generated from the context of the previous queries and answers included in the shared search result.

The terminal 200 may display, in the search room, the entire answer included in the shared search result in response to a request for the full view of the search result shared in the chatroom (S340).

The terminal 200 may display the answer to the keyword query in the search room in response to a selection of the specific keyword if the specific keyword is selected from the shared search result in the chatroom (S350).

The terminal 200 may transmit the query input or selected in the search room to the server 100 and display the answer to the query in the search room (S360). The answer displayed in the search room may be generated based on the context in the search room.

The terminal 200 may transmit a sharing request for the query and the answer to the server 100, and display the search result including the query and the answer in the chat room (S370). The shared search result may include the button with the follow-up query function in the context of the shared query and answer.

The terminal 200 may maintain the search room session while the chatroom session is maintained. In this way, the terminal 200 may acquire the answer generated from the search context and the conversation context.

The flowcharts shown in FIGS. 10 to 12 are examples for describing the present disclosure, in which the order may be changed and the steps may be processed in parallel.

As described above, according to the embodiment, the chatroom may be switched to the search mode to provide the search service, enabling the information search and the information sharing during conversations. The queries and answers may be recorded in a separate space in connection with the chatroom.

According to the embodiment, it is possible to recognize the search context for existing queries and answers, generate the answer through the continuous exploration that preserves the context, and generate the answer by summarizing the integrated information obtained from the various sources, thereby providing the optimal search result.

According to the embodiment, it is possible to recommend the various types of queries, thereby enhancing the convenience of query input and the accessibility to the search service, thereby prompting the search service.

According to the embodiment, the user may query in the chatroom while maintaining the context until reaching the desired information, review the queries and answers in the separate space in connection with the chatroom, and enter the additional query while preserving the context of the search result shared in the chatroom.

The embodiments of the present disclosure described above are not only implemented through the devices and the methods, and may also be implemented through a program that implements the function corresponding to the configuration in the embodiment of the present disclosure or a recording medium on which the program is recorded.

Although the embodiments of the present disclosure have been described in detail hereinabove, the scope of the present disclosure is not limited thereto. That is, various modifications and alterations made by those skilled in the art that use a basic concept of the present disclosure as defined in the following claims also fall within the scope of the present disclosure.

What is claimed is:

1. A method for operating a user terminal, the method comprising:
acquiring, from a server, an answer to a query input or selected in the chatroom or in a specific space, the specific space being in connection with a chatroom; and
displaying the query and the answer in the specific space,
wherein the specific space is configured to cumulatively display queries and answers input or selected in the chatroom or in the specific space.

2. The method of claim 1, wherein a session of the specific space is maintained dependent on a session of the chatroom.

3. The method of claim 1, further comprising:
transmitting a sharing request for the query and the answer to the server; and
displaying a search result including the query and the answer in the chatroom.

4. The method of claim 3, wherein the search result shared in the chatroom further includes
a button configured to perform a follow-up query function in a context of the query and the answer.

5. The method of claim 1, wherein the displaying the query and the answer in the specific space comprises:
transmitting the query input or selected in the chatroom switched to a search mode to the server; and
displaying the answer to the query in the specific space.

6. The method of claim 1, wherein the displaying the query and the answer in the specific space comprises:
in response to a request for a follow-up query related to a search result shared in the chatroom, switching the chatroom to a search mode;
transmitting the query input or selected in the chatroom to the server; and
displaying the answer to the query in the specific space.

7. The method of claim 1, wherein the displaying the query and the answer in the specific space comprises
in response to a request for a full view of a search result shared in the chatroom, displaying the entire answer included in the shared search result in the specific space.

8. The method of claim 1, further comprising:
folding the specific space in response to a user action and displaying, in the chatroom, an entry point configured to enable entry into the specific space; and
unfolding and displaying the specific space in response to a selection of the entry point.

9. The method of claim 1, further comprising:
displaying a previous query list in the specific space; and
displaying an answer to a query selected from the previous query list in the specific space.

10. A method for operating a server, the method comprising:
receiving a query input or selected in a chatroom or in a specific space from a user terminal, the specific space being maintained dependent on a session of the chatroom; and
generating an answer to the query and providing the answer to the specific space,
wherein the specific space is configured to cumulatively display queries and answers input or selected in the chatroom or in the specific space.

11. The method of claim 10, further comprising:
receiving a sharing request for the query and the answer from the user terminal; and
providing a search result including the query and the answer to the chatroom.

12. The method of claim 11, wherein the search result shared in the chatroom further includes
a button configured to perform a follow-up query function in a context of the query and the answer.

13. The method of claim 12, further comprising:
receiving an additional query input from a terminal of a participant within the chatroom, the chatroom being switched to a search mode in response to a selection of the button;
generating an answer to the additional query in the context of the query and the answer; and
providing the answer to the additional query to a specific space for the participant that is maintained dependent on the session of the chatroom.

14. The method of claim 10, further comprising:
in response to a termination of the session of the chatroom, terminating a session of the specific space; and
storing, in a query list, at least one query recorded in the specific space while the session of the specific space is maintained.

15. The method of claim 14, further comprising
providing the query list to the specific space.

16. An application stored on a computer-readable storage medium and executed by a processor, the application comprising instructions for executing:
acquiring, from a server, an answer to a query input or selected in a chatroom or in a specific space, the specific space being in connection with a chatroom; and
displaying the query and the answer in the specific space,
wherein the specific space is configured to cumulatively display queries and answers input or selected in the chatroom or in the specific space.

17. The application of claim 16, comprising instructions for further executing:
transmitting a sharing request for the query and the answer to the server; and
displaying a search result including the query and the answer in the chatroom,
wherein the search result shared in the chatroom further includes
a configured to performbutton configured to perform a follow-up query function in a context of the query and the answer.

18. The application of claim 16, wherein the displaying the query and the answer in the specific space comprises:
transmitting the query input or selected in the chatroom switched to a search mode to the server, and displaying the answer to the query in the specific space;
in response to a request for a follow-up query related to a search result shared in the chatroom, switching the chatroom to the search mode, transmitting the query input or selected in the chatroom to the server, and displaying the answer to the query in the specific space; or
in response to a request for a full view of the search result shared in the chatroom, displaying the entire answer included in the shared search result in the specific space.

19. The application of claim 16, comprising
instructions for further executing:
folding the specific space in response to a user action and displaying, in the chatroom, an entry point configured to enable entry into the specific space; and
unfolding and displaying the specific space in response to a selection of the entry point.

20. The application of claim 16, comprising instructions for further executing:
displaying a previous query list in the specific space, and
displaying an answer to a query selected from the previous query list in the specific space.
